(19) United States
(12) Patent Application Publication
(10) Pub. No.: US 2011/0306259 A1
(43) Pub. Date: Dec. 15, 2011

(54) CLOTH MATERIAL IN A RAW FABRIC STATE, AND METHOD FOR EXPOSING CONDUCTIVE FIBER IN THAT CLOTH MATERIAL

(75) Inventors: Hideaki KUNISADA, Komaki-shi (JP); Takazou FUJII, Obu-shi (JP)

(73) Assignee: TOYOTA BOSHOKU KABUSHIKI KAISHA, Aichi-ken (JP)

(21) Appl. No.: 13/111,145

(22) Filed: May 19, 2011

(30) Foreign Application Priority Data
May 21, 2010 (JP) 2010-117069

(51) Int. Cl. D03D 15/00; B26D 7/32

(52) U.S. Cl. 442/301; 83/23

(57) ABSTRACT

A cloth material in a raw fabric state includes a conductive fiber, and another fiber that is nonconductive. The conductive fiber is arranged along a width direction of the cloth material in a raw fabric state. A first weave portion that is used to create a product such as a seat cover is established at a center, in the width direction, of the cloth material in a raw fabric state. A second weave portion, in which the conductive fiber is arranged in a non-interfering way so as to not go over and under, or be intertwined with, the other fiber in the second weave portion, extends from both ends of the first weave portion.

### INCORPORATION BY REFERENCE

The disclosure of Japanese Patent Application No. 2010-117069 filed on May 21, 2010 including the specification, drawings and abstract is incorporated herein by reference in its entirety.

### BACKGROUND OF THE INVENTION

1. Field of the Invention

The invention relates to cloth material in a raw fabric state that includes conductive fiber, and a conductive fiber exposing method that exposes the conductive fiber at an end portion in a width direction of that cloth material.

2. Description of Related Art

As related art, there is cloth material that includes conductive fibers (i.e., conductive fibers) that generate heat when current is passed through them (i.e., when excited). This kind of cloth material is used as cover material for seats of automobiles, for example, and helps to improve sitting comfort by enabling the temperature of the seat surface to be adjusted. One such cloth material is described in Japanese Patent Application Publication No. 2007-227384 (JP-A-2007-227384) that describes cloth formed of conductive fibers and nonconductive fibers, in which at least a portion of warp and weft is conductive fiber. With such cloth, the conductive fibers go over and under the nonconductive fibers, so it is difficult to connect conducting means to the conductive fibers as they are. Therefore, after cutting the cloth to the size that it needs to be to fit on the seat of the automobile, metallic tape is taped to the surface on both end portions in the direction in which the conductive fibers are arranged, and an onboard power supply is connected via the metallic tape. That is, conducting means (i.e., a power supply) is connected to the conductive fibers via the metallic tape by connecting the points where the conductive fibers are on top to the surface of the metallic tape, thereby enabling current to be applied to the conductive fibers.

### SUMMARY OF THE INVENTION

Incidentally, with the related art, a check for breaks in the conductive fibers is not performed at the raw fabric stage prior to the cloth material being cut. Thus, in view of the possibility that conductive fibers may break in the manufacturing process of the cloth material, the inventors thought that if current could be applied to the conductive fibers at the raw fabric stage, it would be possible to check for breaks in the conductive fibers from the amount of current. However, in the related art, current is only able to be applied to the conductive fibers after first taping the metallic tape to the surface of a piece of cloth after it is cut, when the cloth material is incorporated into a product. Applying current to the conductive fibers at the raw fabric stage before cutting was not envisioned. Therefore, specific means effective for enabling current to be applied to the conductive fibers in the cloth material in a raw fabric state was not proposed.

Thus, the invention provides technology that easily enables current to be applied to the conductive fibers in cloth material in a raw fabric state.

A first aspect of the invention relates to a cloth material in a raw fabric state that includes a conductive fiber, and another fiber that is nonconductive. The conductive fiber is arranged along a width direction of the cloth material in a raw fabric state. A first weave portion that is used to create a product such as a seat cover is established at a center, in the width direction, of the cloth material in a raw fabric state, and a second weave portion, in which the conductive fiber is arranged in a non-interfering way so as to not go over and under, or be intertwined with, the other fiber in the second weave portion, extends from both ends of the first weave portion.

A second aspect of the invention relates to a method for exposing the conductive fiber at an end portion in the width direction of the cloth material in a raw fabric state according to the first aspect. This method includes: cutting the other fiber in a flow direction of the cloth material in a raw fabric state at the second weave portion; and exposing the conductive fiber at the end portion of the cloth material in a raw fabric state by removing the other fiber positioned to an outside, in the width direction, of the cut location.

According to the cloth material in a raw fabric state of the invention, conductive fiber can easily be exposed at an end portion of the cloth material, thereby enabling current to be applied. As a result, it is easy to apply current to the conductive fiber in order to check for a break in the conductive fiber with the cloth material in a raw fabric state prior to cutting just as it is.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a plan view of raw fabric of cloth material according to a first example embodiment of the invention;

FIGS. 2A and 2B are enlarged views of portion II of the raw fabric of the cloth material shown in FIG. 1, that show the process of exposing a conductive fiber;

FIG. 3A is a sectional view taken along line IIIA-IIIA in FIG. 2A of the raw fabric of the cloth material, and FIG. 3 is a sectional view taken along line IIIB-IIIB in FIG. 2B of the raw fabric of the cloth material;

FIG. 4 is a plan view of the raw fabric of the cloth material according to a second example embodiment of the invention;

FIGS. 5A and 5B are views of the weave of a first weave portion of the cloth material shown in FIG. 4;

FIGS. 6A and 6B are views of the weave of a second weave portion of the cloth material shown in FIG. 4;

FIGS. 7A and 7B are enlarged views of portion VII of the raw fabric of the cloth material shown in FIG. 4, that show the process of exposing a conductive fiber;

FIGS. 8A, 8B, 8C, 8D, 8E, and 8F are views of the weave of a first weave portion of the cloth material according to a modified example of the second example embodiment of the invention; and

FIGS. 9A and 9B are views of the weave of a second weave portion of the cloth material according to the modified example of the second example embodiment of the invention.

### DETAILED DESCRIPTION OF EMBODIMENTS

The cloth material according to example embodiments of the invention includes conductive fibers and other fibers. First, these constituent materials will be described. Here, the term “raw fabric state” refers to fabric in a flat state in which it is to be cut in order to create a product such as a seat cover. Also, the term “cloth material” includes i) cloth material that has been made into a cloth state by weaving or knitting, or that is manufactured already in a cloth state without being weaved or knit, such as a fabric, a knit, and nonwoven cloth, ii) cloth material that has been through a dyeing process and a tentering and heat setting process (i.e., a finishing process), and iii) cloth material that has undergone a secondary process, such as a back coating process or a process in which a urethane sheet is flame-laminated to at a portion used to create a product.

Conductive fibers are conductive fiber-like material through which current can pass. The specific resistance (i.e., the volume resistivity) is typically 10° to 10⁻¹² Ω·cm. The specific resistance (i.e., the volume resistivity) can be measured according to Japanese Industrial Standards (JIS) K7194, for example. Examples of the conductive fibers include carbon fiber filament, metal wire, and plated wire rods, among others. The carbon fiber is a polyacrylonitrile based carbon fiber (PAN based carbon fiber) or a pitch based carbon fiber. Of these, a carbon fiber with a firing temperature of 1,000° C. (i.e., carbonized fiber, graphitized fiber, or graphite fiber) is preferably used because it has good electrical conductivity.

Examples of the material of the metal wire include gold, silver, copper, brass, platinum, iron, steel, zinc, tin, nickel, stainless steel, aluminum, and tungsten. Of these, stainless steel metal wire is preferably used because it has excellent corrosion resistance and strength. Here, the type of steel is not particularly limited. Possible examples include SUS304, SUS316, and SUS316L. SUS304 has wide applicability, and SUS316 and SUS316L have good corrosion resistance because they include molybdenum.

The diameter of the metal wire used for the conductive fiber is not particularly limited, but in terms of strength, metal wire with a diameter of φ 10 to 150 μ is preferable considering flexibility. Also, a composite thread in which other fiber material such as polyester fiber is used as the core thread and metal wire is used as the sheath thread, and in which the metal wire is wound around the core thread in twisting directions S and Z may be used, for example. In this case, excellent flexibility is ensured by using metal wire with a small diameter, while tensile strength is increased by the core material.

Also, the metal wire may also have a resin coating on its surface. This kind of metal wire has excellent rust resistance due to the resin layer on the surface. Moreover, the metal can be exposed by easily peeling back the resin layer when connecting conducting means. The coating resin is not particularly limited, and may be urethane, acrylic, silicone, or polyester or the like, but polyurethane is preferable in view of its durability. Also, the thickness of the resin layer may be selected according to the polymer type, the durability, and the use. For example, the thickness may be approximately 0.05 to 500 μm. The coating method is not particularly limited, but a method in which the metal wire is passed through a polymer dispersion liquid to adhere the polymer to it, and then heated to fix the polymer is preferable. Also, after a polymer powder or a polymer melt is adhered to the metal wire, it may be fixed by heating or the like as necessary.

The plated wire rods have a core portion of conductive or nonconductive fiber material, and a metal or alloy plated portion formed on all or a portion of the surface of the core portion. Forming this plated portion enables nonconductive fiber material to be able to conduct electricity. Also, forming a plated portion on conductive fiber material enables the durability to be improved. Examples of nonconductive fiber that can be used as the core portion include para-based aramid fiber, meta-based aramid PBO fiber, polyacrylate fiber, PPS fiber, PEEK fiber, polyimide fiber, fiber glass, alumïna fiber, silicon carbide fiber, and boron fiber. The plated portion can be formed on all or a portion of the surface of the core portion. Examples of metals that can be used in the plating process include tin (Sn), nickel (Ni), gold (Au), silver (Ag), copper (Cu), iron (Fe), lead (Pb), platinum (Pt), zinc (Zn), chrome (Cr), cobalt (Co), and palladium (Pd). Also, examples of alloys that can be used in the plating process include Ni—Sn, Cu—Ni, Cu—Sn, Cu—Zn, and Fe—Ni.

The conductive fibers may preferably be fibers with better heat resistance than other fibers. The temperature at which the fiber melts from heat, or, if the fibers do not melt, the temperature at which the fibers burn, may preferably be higher than that of other fibers. That is, the conductive fibers may have a higher melting point than the other fibers, and thus not melt as easily, or burn as easily, as the other fibers. The limiting oxygen index (LOI) may be used as the flammability index, and the LOI is preferably 26 or greater. The limiting oxygen index (LOI) may be measured according to Japanese Industrial Standards (JIS) K7201 or Japanese Industrial Standards (JIS) L1091 (1999) 8.5E-2. The metal wire generally has a higher melting point than natural fiber or composite fiber used as other fibers. Also, the LOI of the metal wire is typically 26 or greater. For example, the LOI of stainless steel fiber is 49.6. Also, carbon fiber (PAN based carbon fiber and pitch based carbon fiber) does not melt and has a LOI of 60.0 or higher.

The other fibers are nonconductive fibers, examples of which include natural fiber that is plant based and animal based, regenerated fiber such as rayon, semi synthetic fiber such as acetate, synthetic fiber made of resin such as nylon or polyester, and a blend of these fibers. These fibers are insulated fibers in which the specific resistance exceeds 10⁸ Ω·cm.

With the other fibers, the temperature at which they melt from heat, or, if they do not melt, the temperature at which they burn, may preferably be lower than that of the conductive fibers. If the fibers burn instead of melt, the limiting oxygen index (LOI) may be less than 26. Many natural fibers that are plant and animal based natural fibers have a LOI of less than 26. For example, the LOI of cotton is 18 to 20, inclusive, and the LOI of wool is 24 to 25, inclusive.

Also, many synthetic fibers have melting points that are lower than those of the conductive fibers. Also, the flammability of many synthetic fibers is higher than that of the conductive fibers. For example, the LOI of polyester is 18 to 20, inclusive, and the LOI of nylon is 20 to 22, inclusive.

Hereinafter, the structure of the cloth material according to the example embodiments of the invention that is formed using these fiber materials will now be described with reference to the drawings.

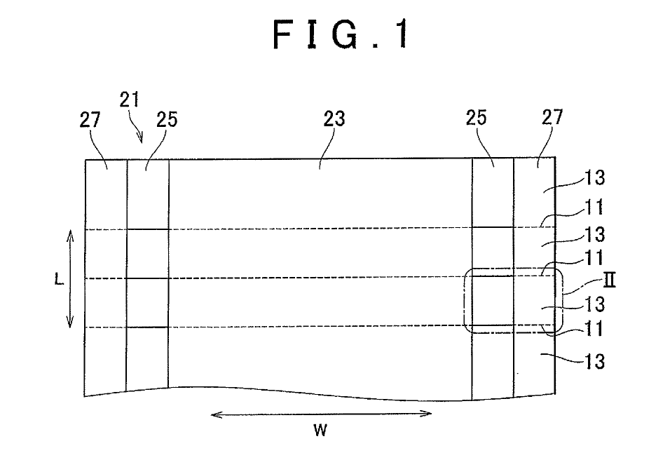

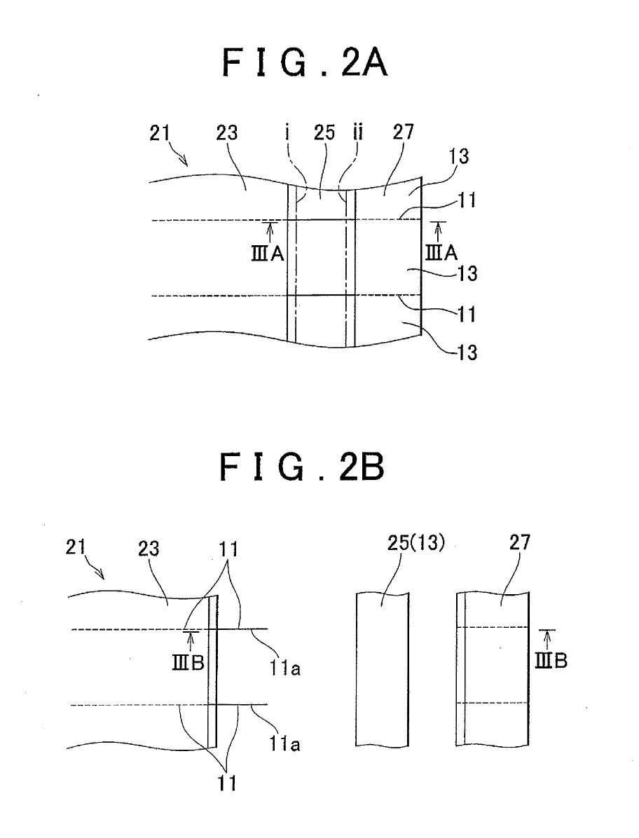

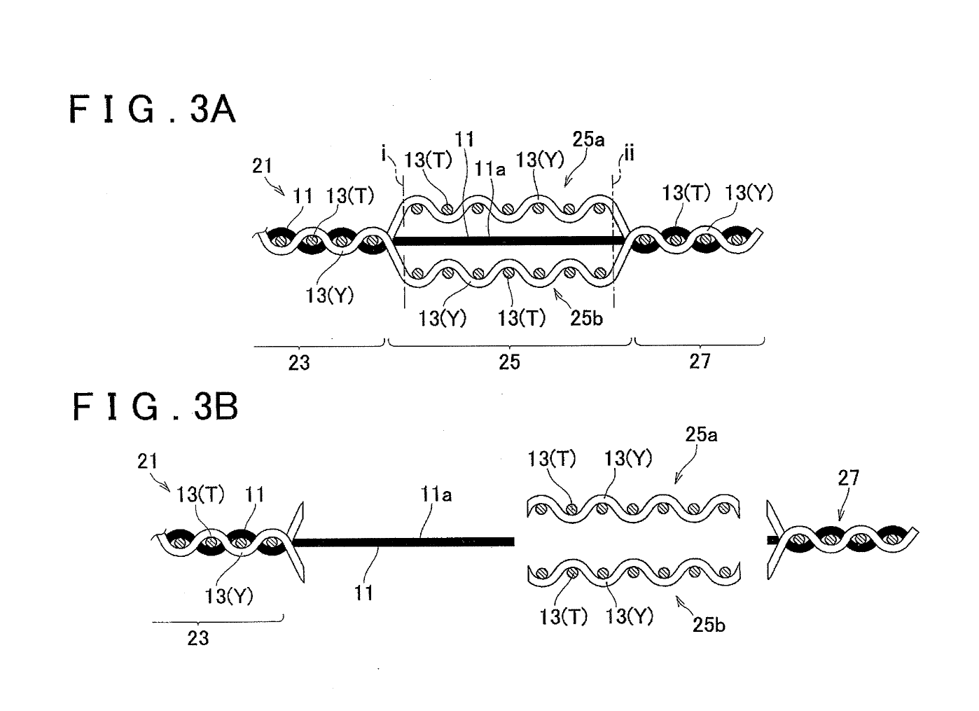

A first example embodiment of the invention will be described with reference to FIGS. 1 to 3. FIGS. 1 and 2 are both plan views showing an extreme frame format of cloth material 21 in a raw fabric state according to this example embodiment. This cloth material 21 is fabric made with conductive fibers 11 and other fibers 13. SUS-PET composite thread in which SUS wire (φ 28 μm) is wound in the S and Z twisting directions around a core material of polyester fiber (333 dtex) is used for the conductive fibers 11. Polyester fiber (333 dtex) is used for the other fibers 13. In FIGS. 1 and 2, in order to facilitate understanding of how the conductive fibers 11 are arranged, only the conductive fibers 11, of the constituent fibers, are exaggerated and simplified. Incidentally, reference characters W and L shown by the arrows in the drawing indicate the width direction and the flow (i.e., length) direction, respectively, of the cloth material 21. With this fabric (i.e., the cloth material 21), the conductive fibers 11 are arranged as a portion of a plurality of weft threads, and the rest of the weft threads and all of the warp threads are formed by the other fibers 13. The conductive fibers 11 are arranged along the width direction at intervals in the flow direction, and the weave construction is formed by only the other fibers 13 in between conductive fibers 11. FIG. 3 is a view showing a frame format of a cross section of the cloth material 21. In FIG. 3, the conductive fiber 11 is shown in black to make it easier to differentiate from the other fibers 13. Also in FIG. 3, reference character (Y) appended to the other fiber 13 indicates that this other fiber 13 is a weft thread, and reference character (T) appended to the other fiber 13 indicates that this other fiber 13 is a warp thread.

As shown in FIG. 1, there is a first weave portion 23, a second weave portion 25, and a third weave portion 27 that are formed of three different weave constructions, in the width direction of the cloth material 21. The first weave portion 23 is positioned in the center of the cloth material 21 and is a portion that is used as the material of a product such as a seat cover, for example. The second weave portion 25 extends from both ends in the width direction of the first weave portion 23, and the third weave portion 27 extends to the outside in the width direction of each second weave portion 25.

The weave construction of the first weave portion 23 is a plain weave. Any of a variety of cloth weaves required by the target product may be used for the weave construction of the first weave portion 23. For example, the first weave portion 23 may be woven with a plain weave, a twill weave, a sateen weave, or a modified weave thereof, or with a special weave or the like. Preferably, the conductive fibers may be arranged on a back side by a double weave, and more particularly, a double weft weave. With this first weave portion 23, the conductive fibers 11 go over and under the other threads 13(T) that are warp threads, thus forming a continuous cloth-like weave with the other threads 13, as shown in FIG. 3A.

The second weave portion 25 has a weave construction in which the conductive fibers 11 do not go over and under the other fibers 13(T) that are warp threads. In this second weave portion 25, a hollow weave is woven with the other fibers 13(T) that are warp threads and the other fibers 13(Y) that are weft threads. Also, the conductive fibers 11 (11a) are arranged so as not to go over and under the other fibers 13 that form cloth-like portions 25a and 25b on the front and back, between the front and back cloth-like portions 25a and 25b formed by the hollow weave.

The third weave portion 27 is relatively dense and has a strong weave construction, and is able to be held by pin stenter. Here, able to be held by pin stenter refers to the fact that pins are able to be inserted and withstand the application of tensile force in the width direction of the cloth material. For example, with a shuttle loom, the selvedge of the twilling is preferably a reverse twill of the same weave, rib weave, cord, or basket taffeta selvedge or the like. These weaves can be used as the weave construction of the third weave portion 27. Also, with a shuttleless loom, a twisted weave, a wrapped weave (a two thread wrap or a three thread wrap), or a tuck in or the like are examples of the weave construction of the third weave portion 27, but a basket weave is preferable. With the third weave portion 27, the conductive fibers 11 goes over and under the other fibers 13(T) that are warp threads, thus forming a continuous cloth-like weave with the other threads 13.

Incidentally, in FIG. 1, the widths of the second weave portion 25 and the third weave portion 27 are shown extremely exaggerated. The proportional relationship of the width dimensions with respect to the first weave portion 23 is shown much different than it actually is. The second weave portion 25 need only be wide enough to enable the conductive fibers to be exposed and the conducting means to be connected, as will be described later. For example, the width of the second weave portion 25 may be approximately 1 to 20 mm, inclusive, or more preferably, 5 to 10 mm, inclusive. Also, the width of the third weave portion 27 is preferably approximately 10 to 30 mm, inclusive, to prevent unraveling and in order to hold it with pin stenter.

With the cloth material 21 having this structure, the conductive fibers 11 are able to be exposed at both end portions in the width direction, as described below.

As shown in FIG. 2A, the other fibers 13 are cut (cutting plane line i; first cutting process) without cutting the conductive fibers 11, at positions in the second weave portions 25 that are toward the first weave portion 23, and the other fibers 13 and the conductive fibers 11 are cut (cutting plane line ii; second cutting process) at positions in the second weave portions 25 that are toward the third weave portions 27. As a result, the conductive fibers 11 (11a) can be exposed at both end portions in the width direction, as shown in FIG. 2B.

That is, in the second cutting process, the third weave portion 27 is cut away (i.e., removed) from the cloth material 21 along the cutting plane line ii in FIG. 3A and separated from the front and back cloth-like portions 25a and 25b formed by the other fibers 13 of the second weave portion 25 at a location toward the outside of the front and back cloth-like portions 25a and 25b in the width direction, as shown in FIG. 3B. Also, in the first cutting process, the front and back cloth-like portions 25a and 25b formed by the other fibers 13 of the second weave portion 25 are separated from the cloth material 21, along the cutting plane line i in FIG. 3A, at a location toward the inside of the front and back cloth-like portions 25a and 25b in the width direction, as shown in FIG. 3B. Accordingly, the front and back cloth-like portions 25a and 25b formed by the other fibers 13 of the second weave portion 25 are also cut away (i.e., removed) from the cloth material 21. As a result, only the conductive fibers 11 (11a) that had been arranged in the second weave portion 25 remain at the end portion of the cloth material 21, and these conductive fibers 11 (11a) extend to the outside in the width direction and are exposed from the cloth-like weave portion of the cloth material 21.

In the first cutting process, one preferable method of cutting the other fibers 13 without cutting the conductive fibers 11 involves cutting by heating means. That is, the polyester fibers that are the other fibers 13 melt at a lower temperature than the SUS wire that is used for the conductive fibers 11, so it is possible to melt through only the other fibers 13 without cutting the conductive fibers 11 by heating at a temperature that is equal to or higher than the melting point of the other fibers 13 (i.e., the polyester fibers) and lower than the melting point of the conductive fibers 11 (i.e., the SUS wire). The melting point of the polyester fibers that serve as the other fibers 13 used in this example embodiment is 264° C., and the melting point of SUS wire (such as SUS 316) that is used for the conductive fibers 11 is between 1,371 and 1,450° C., inclusive, so it is possible to only cut the other fibers 13 by heating them at a temperature between 500 to 1,300° C., inclusive. When the conductive fibers 11 are SUS-PET composite threads, as they are in this example embodiment, and heating means is used for cutting, the polyester fibers that serve as the core material that forms the SUS-PET composite threads can also be cut in the first cutting process, so it is preferable to ultimately also remove the polyester fiber that is the core material to expose only the SUS wire at the end portion of the cloth material 21.

Examples of the heating means include a heating apparatus (such as a punch mechanism or a scissors mechanism) that can physically connect to the cloth material 21, or optical heating means such as a laser. Of these, a laser enables the temperature (i.e., output temperature) to be accurately controlled, and is therefore preferable. Examples of lasers include, for example, a CO2 laser, a YAG laser, an excimer laser, a UV laser, a semiconductor laser, a fiber laser, an LD laser, and an LD excitation solid-state laser. Of these, a CO2 laser in which the absorption of organic matter (i.e., the other fibers 13) is high is preferable. For example, for the output apparatus of the CO2 laser, a Mitsubishi carbon dioxide laser processing machine (Type: 2512H2; Transmitter type: 25SRP; Laser rated output: 1,000 W) may be used as the heating means. It is possible to melt through the other fibers 13 without cutting the conductive fibers 11 by setting the output to equal to or greater than 15 W and less than 25 W (at a frequency of 200 Hz and a processing speed of 1,500 mm/min) at this time.

Incidentally, the laser can be emitted from either the front or the back side of the cloth material 21. Also, inert gas (such as nitrogen or helium) may also be blown at the cloth material 21 with the emission of the laser. Performing the first cutting process in the presence of inert gas makes it possible to prevent or reduce oxidation (combustion) of the conductive fibers 11 due to overheating.

In the second cutting process described above, the cloth material 21 is cut by cutting through all of the conductive fibers 11 and the other fibers 13. The cutting method is not limited. For example, a cutter may be used, or the cloth material 21 may be melted or burned through by heating the conductive fibers 11 and the other fibers 13 at a temperature that is able to cut them, by any one of the various heating means described above. For example, when the Mitsubishi carbon dioxide laser processing machine described above is used as the heating means, the conductive fibers 11 and the other fibers 13 may be cut by setting the output to equal to or greater than 25 W (at a frequency of 200 Hz and processing speed of 500 mm/min).

According to the cloth material 21 having the structure described above, the conductive fibers 11 can easily be exposed at the end portion in the width direction in a raw fabric state, such that current can be applied to them. As a result, the conductive fibers 11 can be checked for breaks by passing current through the conductive fibers 11. The cloth material passes through the dyeing and finishing processes (in which the cloth material 21 is held by pin stenter and undergoes tentering and heat setting) while in a raw fabric state before being cut to create a product after weaving, but exposing the conductive fibers 11 and checking for breaks can be performed at any stage. More specifically, with the cloth material 21 in this example embodiment, a portion 11a of the conductive fibers 11 that is to be exposed and connected to the conducting means is protected by being arranged between the front and back cloth-like portions 25a and 25b of the second weave portion 25, as shown in FIG. 3A. Therefore, that portion 11a is not easily damaged in the dyeing and finishing processes, and the conductive fibers 11 can be exposed and a check for breaks can be performed after the finishing process. In the finishing process, tensile force in the width direction can be applied while reliably holding the cloth material 21 with pin stenter by sticking pins (i.e., needles) of pin stenter into the third weave portion 27. Also, the portion Ha that is to be exposed and connected to the conducting means later is positioned to the inside of the third weave portion 27 in the width direction, so excitation of the conductive fibers 11 will not be affected even if the conductive fibers 11 are damaged (i.e., break) by the pins in the third weave portion 27. Excitation of the conductive fibers 11 is not limited to being performed immediately after the finishing process. That is, the conductive fibers 11 may also be exposed and a check for breaks performed after a secondary process has been performed. For example, a check for breaks in the conductive fibers 11 may be performed after applying a resin coating (i.e., back coating) to the back surface of the cloth material 21 or laminating a urethane sheet. In this case, the secondary process is preferably performed only on the first weave portion 23 that is used as the material of the product, and not on the second weave portion 25. This is because if the secondary process is also performed on the second weave portion 25, the conductive fibers 11 and the other fibers 13 may adhere by the coating material or urethane material or the like, and the other fibers 13 may stick to the conductive fibers 11 (11a) and remain at the end portion of the cloth material 21, even though the other fibers 13 are cut in the first cutting process, and may thus impede the connection between the conducting means and the conductive fibers 11 (11a).

Incidentally, this example embodiment may also be modified in various ways. For example, in the first example embodiment described above, the structure of the second weave portion 25 is such that the double front and back cloth-like portions 25a and 25b that are made up of the other fibers 13 are formed in a hollow weave. In this structure, the conductive fibers 11 (11a) are protected by being arranged between the front and back cloth-like portions 25a and 25b. Therefore, damage to the conductive fibers 11 can be minimized when supplying the cloth material 21 to the finishing process before exposing the conductive fibers 11. However, the structure of the second weave portion 25 is not limited to this. For example, a single cloth-like portion may be formed by the other fibers 13, and the conductive fibers 11 that are weft threads may be arranged so as to continuously go over the warp threads that form this cloth-like portion. Also,

the conductive fibers 11 and the other fibers 13 are not limited to SUS-PET composite threads and polyester fibers. That is, a variety of conductive fibers and other fibers already described in detail may be used in an appropriate combination. Incidentally, if conductive fibers in which a resin coating has been applied to the surface of metal wire are used as the conductive fibers 11, it is preferable, for the cutting in the first cutting process, to offset the original focal point of the laser from the surface of the cloth material 21, for example, and perform cutting using heating means that will heat a wide area. As a result, the resin coating can be removed at the end of the conductive fibers 11 (11a) at the same time that the other fibers 13 are removed, thereby enabling excitation.

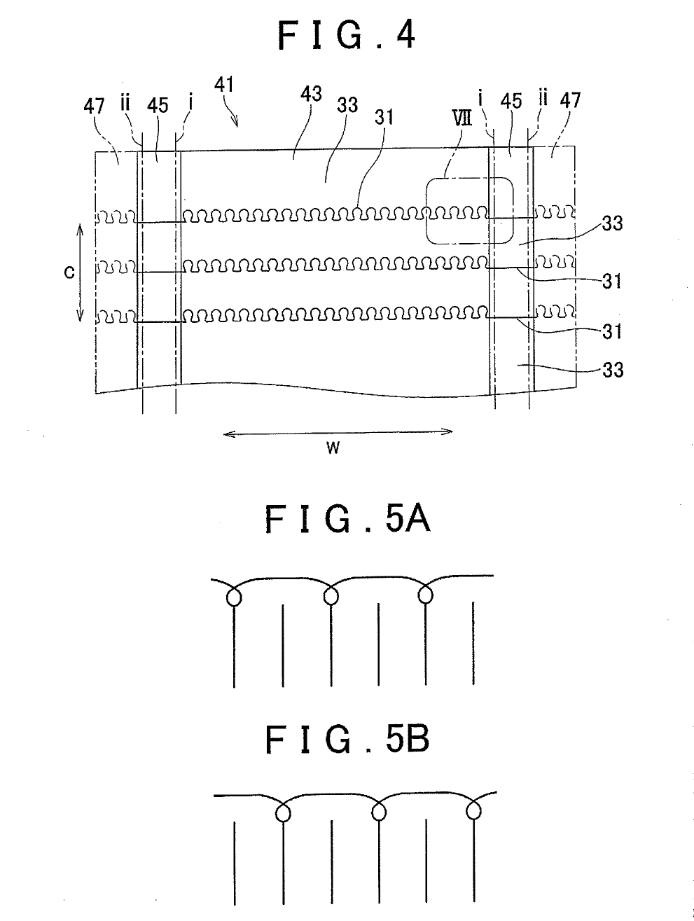

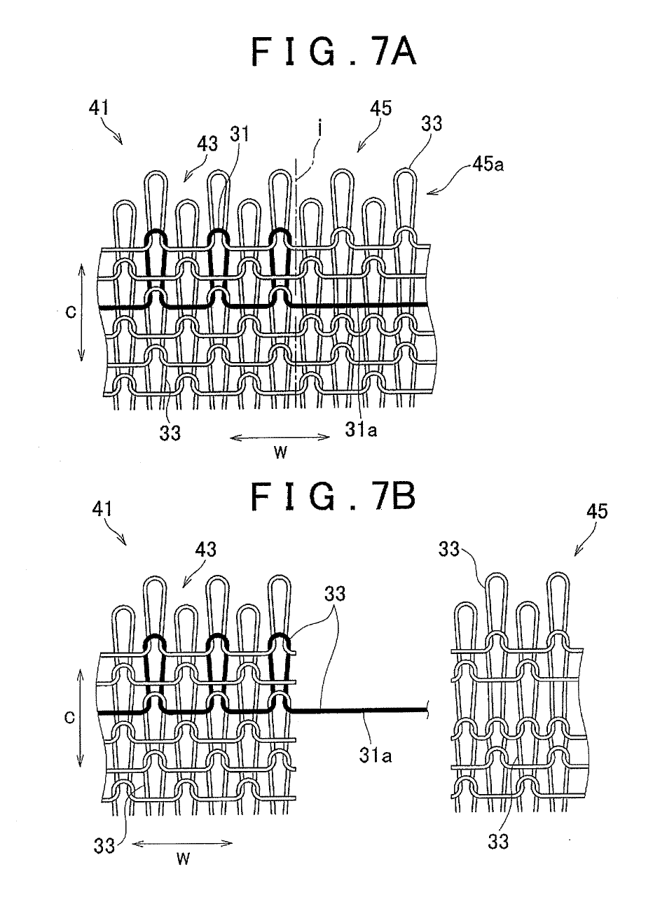

Next, a second example embodiment will be described with reference to FIGS. 4 and 7. FIG. 4 is a plan view showing an extreme frame format of cloth material 41 in a raw fabric state according to this example embodiment. This cloth material 41 is a knit fabric (single jersey) made with conductive fibers 31 and other fibers 33. For the conductive fibers 31, SUS-PET composite thread in which two SUS wires (each with a diameter of φ 50 μm) that are aligned and used as core threads are covered with polyester fibers (167 dtex) used as sheath thread in the S and Z twisting directions (1,000 T/m). Polyester fiber (500 dtex) is used for the other fibers 33. In FIG. 4, in order to facilitate understanding of how the conductive fibers 31 are arranged, only the conductive fibers 31, of the constituent fibers, are exaggerated and simplified. Incidentally, reference characters W and L shown by the arrows in the drawing indicate the width direction and the flow (i.e., length) direction, respectively, of the cloth material 41. With this cloth material 41, the conductive fibers 31 are used only with course 24, from among courses 1 to 24, and the conductive fibers 31 are arranged in the width direction at intervals in the flow direction. FIGS. 7A and 7B are enlarged views showing frame formats of the cloth material 41. In FIGS. 7A and 7B, the conductive fiber 31 is shown in black to make it easier to differentiate from the other fibers 33.

As shown in FIG. 4, a first weave portion 43 that is used as the material of a product such as a seat cover, for example, is in the center of the cloth material 41 in the width direction. Also, a second weave portion 45 extends from both sides of the first construction 43 in the width direction.

The weave of the first weave portion 43 is a Kanako weave (1:1). FIGS. 5A and 5B are views of this weave construction. The weave shown in FIG. 5A is used with odd numbered courses among courses 1 to 24, and the weave shown in FIG. 5B is used with even numbered courses among courses 1 to 24. In this first weave portion 43, as shown in FIG. 7A, a mesh is formed as the conductive fibers 31 and the other fibers 33 are intertwined, and is incorporated into a woven structure, which contributes to the creation of a continuous cloth-like form.

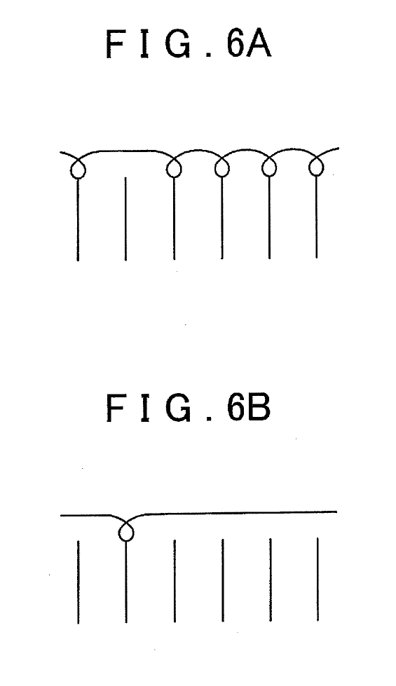

The second weave portion 45 has a weave construction in which the conductive fibers 31 do not form a mesh of knits and tucks and thus are not intertwined with the other fibers 33. Courses 1 to 22 are woven just as they are in the first weave portion 43, but course 23 and course 24 that is woven with the conductive fibers 31 are different. That is, the weave shown in FIG. 6A is used with course 23, and the weave shown in FIG. 6B is used with course 24. As shown in FIG. 7A, in the second weave portion 45, mesh is formed with only the other fibers 33 to create a cloth-like portion 45a, and the conductive fibers 31 (31a) only form minimal loops and go over the other fibers 33 that form the cloth-like portion 45a.

With the cloth material 41 having this structure, the conductive fibers 31 are able to be exposed on both end portions in the width direction, as described below. As shown in FIG. 7, the other fibers 33 are cut (cutting plane line i; first cutting process) without cutting the conductive fibers 31, at positions in the second weave portions 45 that are toward the first weave portion 43. As a result, when the cloth-like portion 45a that is formed by the other fibers 33, of the constituent fibers of the second construction portion 45, is severed from the cloth material 41 and the cloth-like portion 45a formed by the other fibers 33 is peeled away, only the conductive fibers 31 (31a) remain at the end portion of the cloth material 41, so the conductive fibers 31 (31a) extend outward in the width direction from the cloth-like weave portion of the cloth material 41, and are thus exposed. Incidentally, in the first cutting process, a method illustrated in the first cutting process in the first example embodiment described above may be used as the method for cutting the other fibers 33 without cutting the conductive fibers 31.

With the cloth material 41 having the structure described above, the conductive fibers 31 can be exposed at the end portion in the width direction in a raw fabric state, and current can be applied to them. As a result, the conductive fibers 31 can be checked for breaks by applying current to the conductive fibers 31.

Incidentally, this example embodiment may also be modified in a variety of ways. For example, the weave construction of the first weave portion 23 may also employ any one of a variety of woven structures required by the target product. For example, the weave of the first weave portion 23 may be a plain stitch, a rib stitch, a pearl stitch, or a modified weave. Also, the weave construction of the first weave portion 23 is not limited to a single weave (i.e., a single jersey), i.e., it may also be a double weave (double jersey).

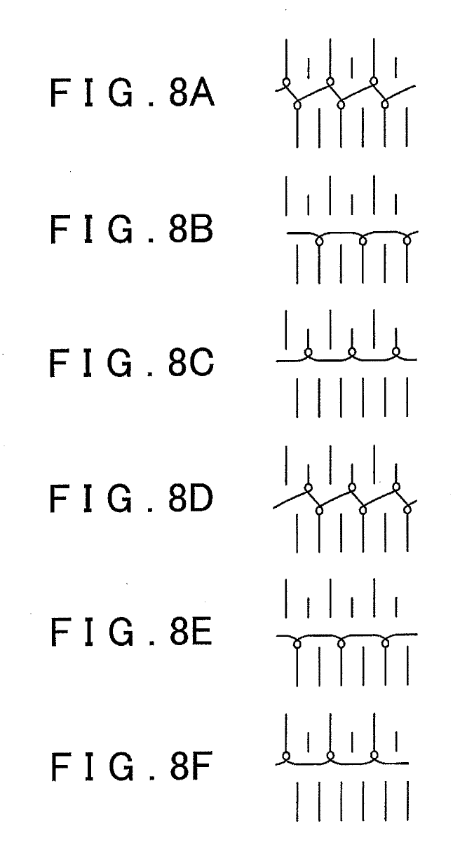

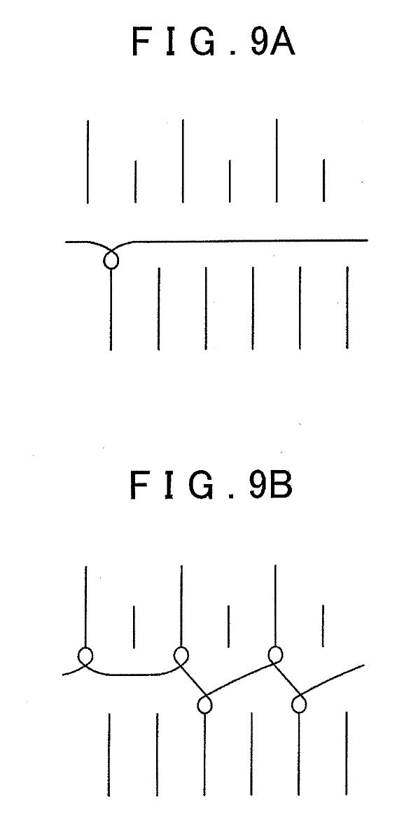

The weaves shown in FIGS. 8 and 9 are examples of a modified example in which the weaves of the first weave portion 43 and the second weave portion 45 have been modified to double jerseys (i.e., double weaves). In this modified example, SUS-PET composite threads that are the same are those in the second example embodiment are used as the conductive fibers, and polyester fibers of a plurality of different thicknesses are used as the other fibers.

The weave construction of the first weave portion 43 is a Mock rody weave. FIGS. 8A to 8F are views of this weave. The weave shown in FIG. 8A is employed with courses 1, 7, 13, and 19, among courses 1 to 24, and polyester fiber (i.e., the other fiber) of 500 dtex is used. With courses 2, 8, 14, and 20, the weave shown in FIG. 8B is employed and polyester fiber (i.e., the other fiber) of 330 dtex is used. With courses 3, 9, 15, and 21, the weave shown in FIG. 8C is employed and with courses 4, 10, 16, and 22, the weave shown in FIG. 8D is employed, and polyester fiber (i.e., the other fiber) of 500 dtex is used. With courses 5, 11, 17, and 23, the weave shown in FIG. 8E is used. Polyester fiber (i.e., the other fiber) of 330 dtex is used with courses 5, 11, and 17, and conductive fiber is used with course 23. With courses 6, 12, 18, and 24, the weave shown in FIG. 8F is employed and polyester fiber (i.e., the other fiber) of 500 dtex is used. With the first weave portion 43 having these weaves, the conductive fibers are arranged inside the double weave cloth material as the back threads of the double jersey, and form a mesh as they intertwine with the other fibers.

Courses 1 to 22 of the second weave portion 45 are the same weaves as the first weave portion 43 shown in FIG. 8, but the weaves of course 24 and course 23 that is woven with the conductive fibers 31 are different. The weave shown in FIG. 9A is employed with the course 23, and the weave shown in FIG. 9B is employed with the course 24. With these weaves, in the second construction portion 45, the conductive fibers only form minimal loops, and are arranged going over the front and back cloth-like portions formed by the other fibers, on the inside of the cloth-like portion having a double weave formed by the other fibers.

With the cloth material having this structure, the conductive fibers are exposed at the end portion by first cutting the other fibers without cutting the conductive fibers at positions in the second weave portions 45 that are toward the first weave portion 43 (i.e., the first cutting process) and then peeling away the cloth-like portion formed by the other fibers of the second weave portions 45.

According to the cloth material having this structure, the conductive fibers are arranged inside the cloth material, so they are not easily damaged by the dyeing and the finishing processes, and after the finishing process, the conductive fibers can be exposed and a check for breaks in the conductive fibers can be performed. The check for breaks can be performed after the back surface of the cloth material is coated with resin (back coated) or a urethane sheet is laminated following the finishing process. In this case, the secondary process is preferably performed only on the first weave portion 43 that is used as the material of the product, and not on the second weave portion 45. This makes it possible to prevent the other fibers from becoming difficult to peel back due to the other fibers and the conductive fibers sticking together by the coating material or the urethane material at the second weave portion 45.

Incidentally, even with cloth material as a knit fabric as in the second example embodiment or the modified example, third weave portions (selvedge portions) 47 that can be held by pin stenter preferably extend along the terminal end portions in the width direction, as shown by the alternate long and two short dashes line in FIG. 4. In this case, as shown in FIG. 4, the other fibers 33 are cut (cutting plane line i; first cutting process) without cutting the conductive fibers 31, at positions in the second weave portions 45 that are toward the first weave portion 43, and the other fibers 33 and the conductive fibers 31 are cut (cutting plane line ii; second cutting process) at positions in the second weave portions 45 that are toward the third weave portions 47. As a result, the conductive fibers 31 can be exposed at both end portions in the width direction. That is, the third weave portions 47 are cut away (i.e., removed) along the cutting lines ii by the second cutting process, and the other fibers 33 of the second weave portion 45 are peeled away (i.e., removed) from the cloth material 41 along the cutting lines i by the first cutting process. As a result, only the conductive fibers 31 (31a) that are arranged in the second weave portion 45 remain at the end portions of the cloth material 41, such that the conductive fibers 31 can be exposed at the cloth-like end portions of the cloth material 41.

Also, in the first and second example embodiments described above, cloth material into which conductive fibers have been woven or knitted when forming the cloth material by weaving or knitting a woven fabric or a knit fabric is given as an example, but the invention is not limited to this. That is, cloth material that retains conductive fibers by the conductive fibers being sewn into or adhered to the cloth material may also be used. In this case, in the first weave portion, the conductive fibers may be integrated into the base fabric by being sewn into or adhered to a base fabric, and in the second weave portion, the conductive fibers may be arranged without being sewn into or adhered to the base fabric, and thus not connected to the other fibers.

Hereinafter, the outline of the above described embodiments of the invention will be described below.

One of the embodiments relates to a cloth material in a raw fabric state that includes a conductive fiber, and another fiber that is nonconductive. The conductive fiber is arranged along a width direction of the cloth material in a raw fabric state. A first weave portion that is used to create a product such as a seat cover is established at a center, in the width direction, of the cloth material in a raw fabric state, and a second weave portion, in which the conductive fiber is arranged in a non-interfering way so as to not go over and under, or be intertwined with, the other fiber in the second weave portion, extends from both ends of the first weave portion.

In the cloth material in a raw fabric state according to this aspect, the other fiber may be cut in a flow direction of the cloth material in a raw fabric state at the second weave portion, and the conductive fiber may be exposed at the end portion of the cloth material in a raw fabric state by removing the other fiber positioned to an outside in the width direction of the cut location. According to this, structure, in the second weave portion, the conductive fiber is arranged in a non-interfering way so as to not go over and under, or be intertwined with, the other fiber. Therefore, if the other fiber is cut in the flow direction of the cloth material in a raw fabric state, it is easy to remove only the other fiber that is positioned to the outside of that cut location in the width direction, so the conductive fiber can be exposed at the end portion of the cloth material.

In the cloth material in a raw fabric state described above, a third weave portion that is held by pin stenter may extend outward in the width direction of the second weave portion. According to this structure, not only can the tentering process with pin stenter be performed smoothly, but the end portion will not easily fray in the dyeing process and the like.

In the cloth material in a raw fabric state described above, the third weave portion may be cut and the other fiber may be cut in a flow direction of the cloth material in a raw fabric state at the second weave portion, and the conductive fiber may be exposed at the end portion of the cloth material in a raw fabric state by removing the other fiber positioned to an outside, in the width direction of the cloth material in a raw fabric state, of the cut location.

In the cloth material in a raw fabric state described above, a melting point of the conductive fiber may be higher than a melting point of the other fiber.

In the cloth material in a raw fabric state described above, the other fiber may be cut in a flow direction of the cloth material in a raw fabric state at the second weave portion, and the conductive fiber may be exposed at the end portion of the cloth material in a raw fabric state by removing the other fiber positioned to an outside, in the width direction, of the cut location. Also, the other fiber may be cut in the flow direction of the cloth material in a raw fabric state by heating the second weave portion at a temperature that is equal to or higher than a melting point of the other fiber and lower than a melting point of the conductive fiber.

While some embodiments of the invention have been illustrated above, it is to be understood that the invention is not limited to details of the illustrated embodiments, but may be embodied with various changes, modifications or improvements, which may occur to those skilled in the art, without departing from the scope of the invention.

What is claimed is:

1. A cloth material in a raw fabric state, comprising:
a conductive fiber; and
another fiber that is nonconductive,
wherein the conductive fiber is arranged along a width direction of the cloth material in a raw fabric state; a first weave portion that is used to create a product such as a seat cover is established at a center, in the width direction, of the cloth material in a raw fabric state; and a second weave portion, in which the conductive fiber is arranged in a non-interfering way so as to not go over and under, or be intertwined with, the other fiber in the second weave portion, extends from both ends of the first weave portion.

2. The cloth material in a raw fabric state according to claim 1, wherein a third weave portion that is held by pin stenter extends outward in the width direction of the second weave portion.

3. The cloth material in a raw fabric state according to claim 1, wherein a melting point of the conductive fiber is higher than a melting point of the other fiber.

4. A method for exposing the conductive fiber at an end portion in the width direction of the cloth material in a raw fabric state according to claim 1, comprising:
cutting the other fiber in a flow direction of the cloth material in a raw fabric state at the second weave portion, and exposing the conductive fiber at the end portion of the cloth material in a raw fabric state by removing the other fiber positioned to an outside, in the width direction, of the cut location.

5. A method for exposing the conductive fiber at an end portion in the width direction of the cloth material in a raw fabric state according to claim 2, comprising:
cutting the third weave portion and cutting the other fiber in a flow direction of the cloth material in a raw fabric state at the second weave portion, and exposing the conductive fiber at the end portion of the cloth material in a raw fabric state by removing the other fiber positioned to an outside, in the width direction of the cloth material in a raw fabric state, of the cut location.

6. A method for exposing the conductive fiber at an end portion in the width direction of the cloth material in a raw fabric state according to claim 3, comprising:
cutting the other fiber in a flow direction of the cloth material in a raw fabric state at the second weave portion, and exposing the conductive fiber at the end portion of the cloth material in a raw fabric state by removing the other fiber positioned to an outside, in the width direction, of the cut location, wherein the other fiber is cut in the flow direction of the cloth material in a raw fabric state by heating the second weave portion at a temperature that is equal to or higher than the melting point of the other fiber and lower than the melting point of the conductive fiber.
